(19) United States
(12) Patent Application Publication
(10) Pub. No.: US 2002/0164190 A1
(43) Pub. Date: Nov. 7, 2002

(54) Imaging media tray loading access

(76) Inventor: Sunny E. Hill, Caldwell, ID (US)

Correspondence Address: HEWLETT-PACKARD COMPANY, Intellectual Property Administration, P.O. Box 272400, Fort Collins, CO, 80527-2400, US

(21) Appl. No.: 09/850,995

(22) Filed: May 7, 2001

(51) Int. Cl. B41J 11/58; B41J 13/10; B41J 3/39; B41J 29/02; B41J 29/12

(52) U.S. Cl. 400/624; 400/625; 400/691

(57) ABSTRACT

An imaging media tray is provided for use in an imaging system having a housing. The tray includes an imaging media holding portion adapted and constructed to retain imaging media in position for processing by the imaging system. At least one tray closure element is movably connected directly to the imaging media holding portion. The at least one closure element is movable between a first, open position permitting insertion of imaging media into the imaging media holding portion without movement of the imaging media holding portion with respect to the housing of the imaging system, and a second, closed position in which the imaging media is in position for processing by the imaging system. In an embodiment, the at least one tray closure element is provided as a door having a generally rectangular cross-section including a top, a bottom, a left side, and a right side. The left and right sides of the door have a height that is substantially less than a length of the top and bottom. A pivoting connection can be used to secure the door to the imaging media holding portion. The pivoting connection can be connected to a lower portion of the door, with a pair of pivot connections located at opposite sides of the door. A selectively releasable latch can be provided to secure the door to the imaging media holding portion. The at least one tray closure element can form a portion of the housing of the imaging system.

### FIELD OF THE INVENTION

The invention relates generally to imaging systems. Specifically, the invention relates to imaging media trays having improved accessibility and ease of use.

### BACKGROUND OF THE INVENTION

Imaging systems such as printers, fax machines, and copiers are virtually omnipresent, and can be found in homes and offices worldwide. The development of such systems has facilitated improvements in communications that have in turn fostered profound changes in the ways that people live and work. Telecommuting, “virtual” offices, and intra-office networks represent but a few examples of the advancements that have been made possible by modern imaging systems.

The loading and unloading of imaging media, such as paper or transparencies, is critical to the operation of imaging systems. The loading sequence of a LaserJet® 4000, shown at P in FIG. 1, provides a typical example. Loading the first tray T1 involves first opening the front access door D of the printer P, then pulling out a tray extension E. Side guides are set to accommodate the imaging media size, and the imaging media is loaded into the tray T1. The door D remains open during use. Loading the second tray T2 requires pulling the tray T2 out of the printer P. The tray is then adjusted as necessary to accommodate the imaging media size, and the imaging media is loaded into the tray T2. The tray is then slid back into the printer P, which is then ready for further operation.

Other media handling mechanisms are also known. For example, U.S. Pat. No. 5,454,553 to Firl et al. is directed to a computer printer tray system including a paper input tray and a paper output tray, neither of which is required to have any moving parts. The output tray is supported in part by the input tray and both trays of the system are semi-permanently cantilever supported from the front of the printer so that neither tray has to be removed when loading an unprinted stack of cut sheet paper or removing printed paper. The output tray has a first portion which is inclined from a second portion by about 10° to correct paper curl caused by a wet printing process.

U.S. Pat. No. 6,120,201 to McKay shows a low-profile printer including a main housing portion, a front portion, a media transport mechanism, a print mechanism and a media tray. The front portion is pivotally or detachably secured to the main housing portion. The media tray is positioned inside the main housing portion. In a preferred embodiment, the media transport mechanism and print mechanism are mechanically coupled to the front portion. The media transport mechanism, the print mechanism and the media tray are accessible when the front portion is in an opened position.

U.S. Pat. No. 5,785,308 to Flores et al. discusses a media pass through configuration for printers in which media is fed from superimposed and removable media holders, such as trays, through a media path to a print engine. A rack disposed in either the frame of the printer or other modular and stackable media option, is dimensioned for receiving at least one media carrying, removable tray disposed beneath the print engine. A door, hinge and latch combination are provided such that the hinge is connected intermediate the door and either the frame of the printer or the frame of the modular option. The door opens in a plane swingable substantially about one edge of the media path extending longitudinally to the print engine, and outwardly and away from the front of the tray. The latch is positioned remotely from the hinge for moveably attaching the door to the printer in a position confronting the tray when the door is in a closed or first position, and open for facilitating tray removal when the door is in an open or second position. A media guide is mounted on the interior of the door for guiding different media in front of the tray, into the media guide path and to the print engine. In one instance, the media guide includes a chute having converging interior walls therein for urging media therethrough in a predetermined path. In another configuration, the media guide includes a portion of the chute on the door and a second portion of the chute formed on the portion of the tray confronting the interior of the door. In either of the forgoing, the doors may be individually opened to allow entrance to the confronting media tray or ganged to permit simultaneous access to all the trays and media being fed to the print engine.

While these known systems provide certain advantages, each of them requires a significant amount of clearance space to permit door opening or tray removal. It can be seen from the foregoing that the need exists for a simple, inexpensive, imaging media loading system that provides easy access to the imaging media supply while minimizing required space.

### SUMMARY OF THE INVENTION

The present invention is directed to an imaging media tray for use in an imaging system having a housing. The tray includes an imaging media holding portion adapted and constructed to retain imaging media in position for processing by the imaging system. At least one tray closure element is movably connected directly to the imaging media holding portion. The at least one closure element is movable between a first, open position permitting insertion of imaging media into the imaging media holding portion without movement of the imaging media holding portion with respect to the housing of the imaging system, and a second, closed position in which the imaging media is in position for processing by the imaging system.

In an embodiment, the at least one tray closure element is provided as a door having a generally rectangular cross-section including a top, a bottom, a left side, and a right side. The left and right sides of the door have a height that is substantially less than a length of the top and bottom.

A pivoting connection can be used to secure the door to the imaging media holding portion. The pivoting connection can be connected to a lower portion of the door, with a pair of pivot connections located at opposite sides of the door. A selectively releasable latch can be provided to secure the door to the imaging media holding portion. The at least one tray closure element can form a portion of the housing of the imaging system.

### DESCRIPTION OF THE DRAWINGS

FIG. 1 is a schematic perspective view of a known imaging system.

FIG. 2 is a schematic perspective view of an imaging media tray in accordance with the principles of the present invention.

FIG. 3 is a schematic elevational view of an imaging media tray in accordance with the principles of the present invention in position in an imaging system.

FIG. 4 is a schematic elevational view showing the FIG. 3 tray in an opening position.

FIG. 5 is a schematic elevational view showing the FIG. 3 tray in an open position, prepared for loading.

FIG. 6 is a schematic elevational view showing the FIG. 3 tray in a closed position.

### DETAILED DESCRIPTION OF THE INVENTION

A tray 10 in accordance with the principles of the present invention is shown in FIG. 2. The tray 10 includes an imaging media holding portion or enclosure 12 adapted and constructed to retain imaging media, such as paper, transparencies, and the like, in position for processing by an imaging system. The imaging media holding portion 12 is composed of a tray bottom 14 flanked on its opposite sides by a pair of generally parallel, upstanding sidewalls 16, 18. A tray end wall 20 is connected to the tray bottom 14 and to the tray sidewalls 16, 18. The respective components of the imaging media holding portion 12 can be fabricated from any suitably rigid and durable material, such as plastics, and can be unitarily molded, or formed separately and secured together by welding or adhesives, as is suitable for the particular imaging system.

A tray closure element 22 is movably connected directly to the tray bottom 14 and the tray sidewalls 16, 18 at a position opposite and generally parallel to the tray end wall 20. The tray closure element 22 can be connected in any suitable way. It is contemplated that particular advantages can be attained by connecting the tray 22 to the tray bottom 14 using a pair of pivot connections 24. The pivot connections 24 are connected to a lower portion of the tray closure element 22. A selectively releasable latch 26 can be provided to secure the tray closure element 22 to the imaging media holding portion 12. The latch 26 can be provided as any suitable known latching mechanism, such as a magnetic connection, hook-and-loop fasteners, or a clasp arrangement.

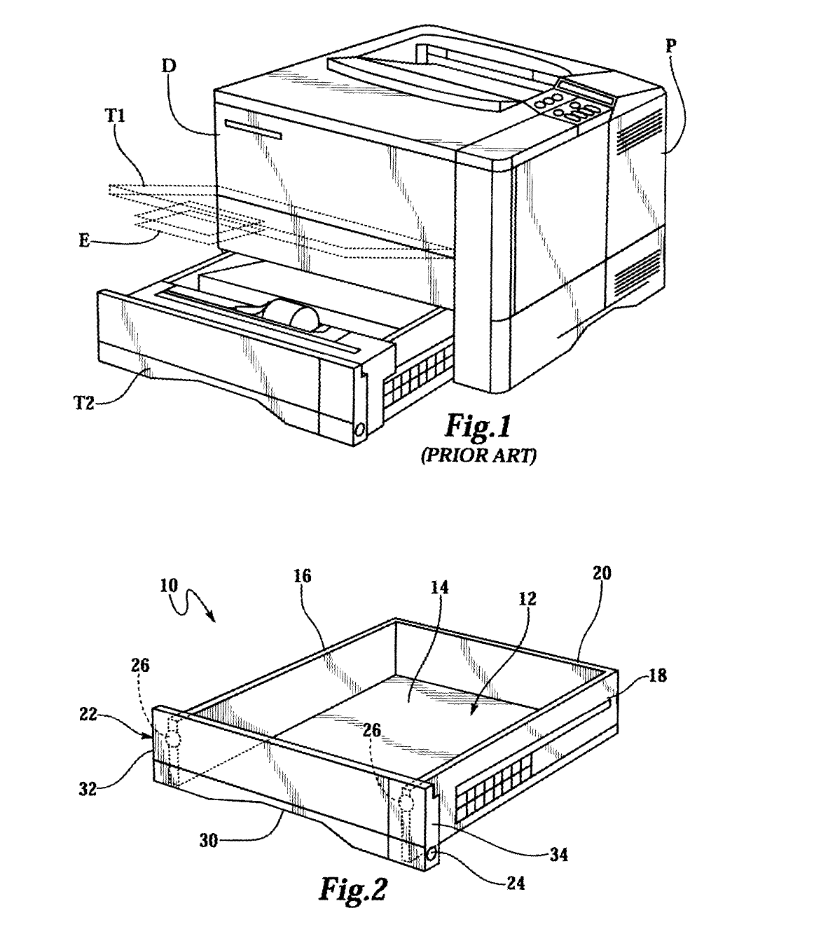

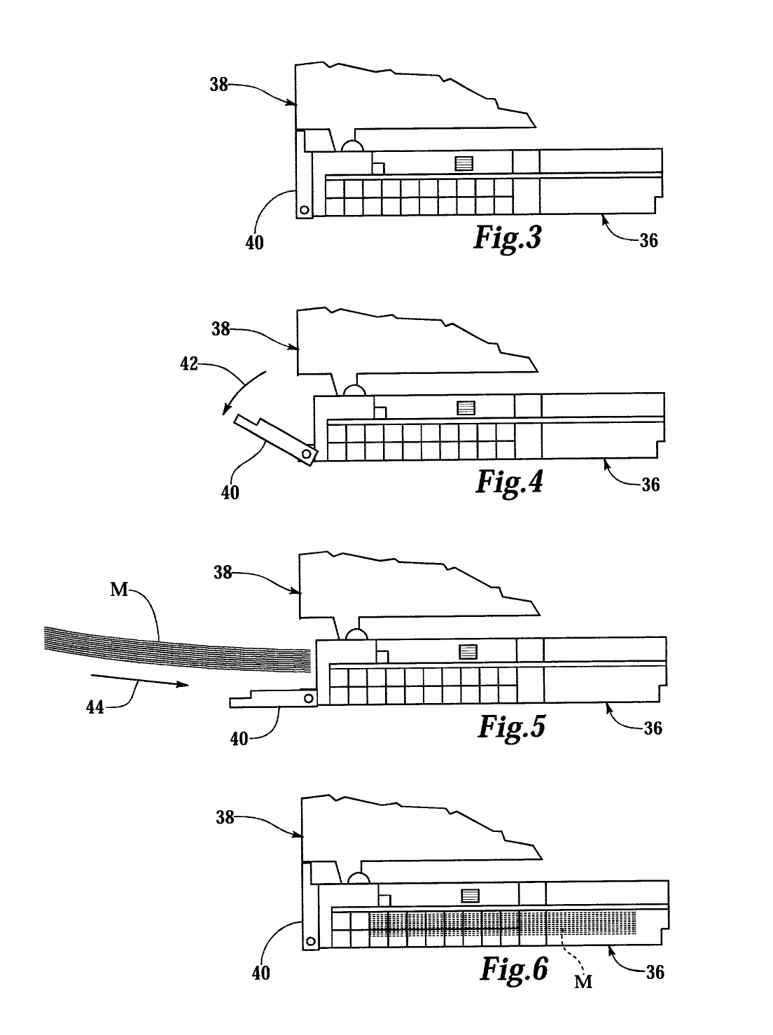

In the illustrated embodiment, the tray closure element 22 is configured with outer contours to form a portion of the housing of the imaging system, as it is shown in FIG. 1. The tray closure element 22 has a generally rectangular cross-section including a top 28, a bottom 30, a left side 32, and a right side 34. The left and right sides 32, 34 of the tray closure element 22 have a height that is substantially less than a length of the top 28 and the bottom 30. These dimensional relationships and pivoting movement result in a significant space-saving feature, since the tray closure element 22 pivots downwardly, as will be described with reference to FIGS. 3-6.

FIG. 3 shows a shows tray 36 incorporating the principles of the present invention. The tray 36 is installed in an imaging system, here a printer 38. The tray 36 includes a tray closure element 40, shown in its closed position in FIG. 3.

As shown in FIG. 4, the tray closure element 40 pivots downwardly, in the direction of the arrow 42. The tray closure element 40 pivots until it reaches a first, open position permitting insertion of imaging media M into the tray 36, as shown in FIG. 5. The imaging media M is inserted into the tray 36 in the direction of the arrow 44, and the tray closure element 40 is returned to its closed position, in which the imaging media M is in position for processing by the imaging system 38.

It will be appreciated by those of skill in the art that this arrangement can be varied, for example, by providing the tray with size adjustment mechanisms, or imaging media feed mechanisms. The present invention provides convenience by reducing the amount of space needed for routine imaging media loading, and by reducing the need for tray removal. This results in simultaneously reducing the likelihood of misalignment or incorrect reinsertion of the tray.

Although the present invention has been described with reference to specific embodiments, those of skill in the art will recognize that changes may be made thereto without departing from the scope and spirit of the invention as defined by the appended claims.

What is claimed is:

1. An imaging media tray for use in an imaging system having a housing, the tray comprising the following:
an imaging media holding portion adapted and constructed to retain imaging media in position for processing by the imaging system; and
at least one tray closure element movably connected directly to the imaging media holding portion, the at least one closure element being movable between a first, open position permitting insertion of imaging media into the imaging media holding portion without movement of the imaging media holding portion with respect to the housing of the imaging system, and a second, closed position in which the imaging media is in position for processing by the imaging system.

2. A tray in accordance with claim 1, wherein the at least one tray closure element comprises a door having a generally rectangular cross-section including a top, a bottom, a left side, and a right side.

3. A tray in accordance with claim 2, wherein the left and right sides of the door have a height that is substantially less than a length of the top and bottom.

4. A tray in accordance with claim 3, further comprising a pivoting connection securing the door to the imaging media holding portion.

5. A tray in accordance with claim 4, wherein the pivoting connection located at a lower portion of the door.

6. A tray in accordance with claim 5, wherein the pivoting connection comprises a pair of pivot connections located at opposite sides of the door.

7. A tray in accordance with claim 2, further comprising a selectively releasable latch securing the door to the imaging media holding portion.

8. A tray in accordance with claim 1, wherein the at least one tray closure element comprises a portion of the housing of the imaging system.

9. An imaging media tray for use in an imaging system having a housing, the tray comprising the following:
a generally rectangular tray bottom;
a pair of tray sidewalls connected to the tray bottom, the sidewalls being disposed parallel to one another and upwardly from the tray bottom on opposite sides of the tray bottom;
a tray end wall connected to the tray bottom and to the tray sidewalls; and
a tray closure element movably connected directly to the tray bottom and the tray sidewalls at a position opposite and generally parallel to the tray end wall, the tray bottom, tray sidewalls, and tray end wall together defining an enclosure for retaining imaging media in position for processing by the imaging system, and the tray closure member provides access for loading and unloading imaging media to and from the enclosure.

10. A tray in accordance with claim 9, further comprising a pivoting connection securing the tray closure element to the tray bottom.

11. A tray in accordance with claim 10, wherein the pivoting connection is located at a lower portion of the tray closure element.

12. A tray in accordance with claim 11, wherein the pivoting connection comprises a pair of pivot connections located at opposite sides of the tray closure element.

13. A tray in accordance with claim 10, further comprising a selectively releasable latch securing the door to the sidewalls.

14. A tray in accordance with claim 10, wherein the tray closure element comprises a portion of the housing of the imaging system.

15. In an imaging system having a housing, a method of loading imaging media into a tray, the method comprising the following steps:
providing a tray including an imaging media holding portion adapted and constructed to retain imaging media in position for processing by the imaging system, the tray further including at least one tray closure element movably connected directly to the imaging media holding portion;
moving the tray closure element to a first, open position;
inserting imaging media into the imaging media holding portion without movement of the imaging media holding portion with respect to the housing of the imaging system; and
moving the tray closure element to a second, closed position in which the imaging media is in position for processing by the imaging system.

17. A method in accordance with claim 16, wherein the step of providing a tray includes providing a pivoting connection located at opposite sides of the at least one tray closure element.

18. A method in accordance with claim 17, wherein the step of moving the tray closure element to a first, open position comprises pivoting the tray closure element in a downward direction.

19. A method in accordance with claim 16, further comprising the step of providing a selectively releasable latch securing the tray closure element to the imaging media holding portion.

20. A method in accordance with claim 16, wherein the step of providing a tray further comprises providing a tray closure element forming a portion of the housing of the imaging system.
